(19) United States
(12) Patent Application Publication
(10) Pub. No.: US 2025/0223802 A1
(43) Pub. Date: Jul. 10, 2025

(54) BIODEGRADABLE FLOORING PRODUCTS

(71) Applicant: F2F Technologies LLC, Dalton, GA (US)

(72) Inventors: Edward Clayton Miller, Rocky Face, GA (US); Andrew Smith Miller, Peachtree Corners, GA (US); Bryan Clayton Miller, Irving, TX (US); William Chase Miller, Dalton, GA (US); William Kelly Williams, Dalton, GA (US); George C. Chang, Fairfield, NJ (US); Kewei Lu, Changzhou City (CN)

(21) Appl. No.: 18/965,447

(22) Filed: Dec. 2, 2024

Related U.S. Application Data
(60) Provisional application No. 63/618,000, filed on Jan. 5, 2024.

(51) Int. Cl. E04B 5/02; C08L 67/04

(52) U.S. Cl. CPC E04B 5/026; C08L 67/04; C08L 2201/06

(57) ABSTRACT

Single-layered and multi-layered polymer-based flooring products are provided, which are formulated and constructed in such a manner as to render the products susceptible to biodegradation under controlled anaerobic conditions. More particularly, the polymer-based flooring products may contain a biodegradable additive that enhances the susceptibility of the thermoplastic polymer in the flooring product to anaerobic biodegradation. Thus, the resulting flooring products are environmentally-friendly and can naturally degrade in landfill conditions over time.

### RELATED APPLICATIONS

This application claims the priority benefit under 35 U.S.C. § 119 (e) of U.S. Provisional Patent Application Ser. No. 63/618,000 entitled “BIODEGRADABLE FLOORING PRODUCTS,” filed Jan. 5, 2024, the entire disclosure of which is incorporated herein by reference.

### BACKGROUND

### 1. Field of the Invention

The present invention is generally concerned with single-layered or multi-layered polymer-based products, which are formulated and constructed in such a manner as to render the products susceptible to biodegradation under controlled anaerobic conditions.

### 2. Description of the Related Art

Floorcovering products are articles of manufacture designed to be installed over existing structural floors, covering the structural floors either wholly or partially. Such products are mainly installed for aesthetic effect, but may also serve other purposes including, but not limited to, increased walking comfort, sound insulation, and heat insulation. Floorcovering products may be installed in buildings, such as domestic dwellings, entertainment venues, educational establishments, health care facilities, hotels, offices, and manufacturing facilities. They also find use in a range of transportation applications, such as in automobiles, ships, trains, coaches, and aircraft.

With the development of synthetic thermoplastic polymers during the 20th century, floorcovering products based on these materials were rapidly produced and gained a considerable market share. A representative example of this type of floorcovering product, often referred to as “vinyl flooring,” is Cushionflor®, which refers to a range of products developed in the 1960's and 1970's by Nairn Floors. A specific example from this product range was Cushionflor Classic®, which consisted of three layers of plasticized polyvinyl chloride (“PVC”) formulations. The first layer consisted of a base sheet that contained a high level of mineral filler, the second layer was a foamable plastisol, and the third layer was a clear plastisol, referred to as a “wearlayer.” The second layer was printed with a desired pattern prior to being coated with the clear layer and foamed. Some of the inks used in the printing process contained chemicals that suppressed the foaming of the second layer during the final curing process, thereby resulting in an embossed or sculpted surface on the final product. The patterns on such products may have been purely decorative and/or may have been applied to resemble other materials when installed on the floor, such as marble or wood.

Since the 1970's, development of these hard floorcovering products by manufacturers throughout the world has continued, in particular to provide products utilizing polymer formulations based on other thermoplastics besides PVC.

While the cost of these thermoplastic-based floorcovering products varies considerably, many are relatively inexpensive, and thus may be replaced, for purely aesthetic reasons, within a short time after installation; rather than being retained until they have reached the end of their useful life through wear and damage. Thus, there is a problem in dealing with considerable quantities of discarded floorcovering products after their removal.

While there may be an option of melt recycling and re-use of this type of product, for example as filled base sheet for multilayer products, this is only applicable to certain types of thermoplastic products. Furthermore, this approach would be primarily limited to post-industrial waste, such as edge trimmings and off-spec products, collected and utilized within the manufacturing plant, and would not be technically or economically viable with post-consumer scrap.

Another disposal method involves recovering at least a portion of the energy from the discarded floorcovering products through incineration; however, such plants are not widespread, and there is considerable public opposition to the construction of more. Furthermore, the incineration of such materials can increase the carbon footprint and release undesirable byproducts into the environment, both of which are undesirable outcomes at this time.

Consequently, the vast majority of scrap floorcovering products will end up in landfill sites and, being based on synthetic thermoplastic polymers, will not degrade under such conditions within acceptable timescales, if at all. With current landfill sites rapidly reaching capacity, and public opposition to opening up more, this constitutes a major environmental problem.

Technically speaking, it could be possible to produce types of floorcovering products based on polymers that are inherently biodegradable, such as aliphatic polyesters (e.g., polylactide and polyhydroxybutyrate). Products based on such polymers could degrade into low molecular weight species within an acceptable timescale under controlled conditions. However, the cost of such polymers remains high, and it is unclear whether they would have the wear properties necessary to be a successful floorcovering material. Also, the biodegradability of such products would not be controllable while they are in use, potentially leading to problems of staining and premature degradation.

Accordingly, further research and development are necessary in order to develop floorcovering products that can address the environmental issues associated with the floorcovering products currently available.

### SUMMARY

One or more embodiments generally concern a flooring product comprising at least one layer, wherein the layer comprises a polymer composition containing at least one inherently non-biodegradable thermoplastic polymer and at least one biodegradation-inducing additive. The biodegradation-inducing additive renders the flooring product susceptible to biodegradation under controlled anaerobic conditions.

One or more embodiments generally concern a multilayered flooring product comprising a first layer and a second layer. The first layer may comprise a polymer composition containing at least one inherently non-biodegradable thermoplastic polymer and at least one biodegradation-inducing additive. Typically, the biodegradation-inducing additive renders the first layer susceptible to biodegradation under controlled anaerobic conditions and the flooring product exhibits a biodegradation of at least 50 percent after 150 days as measured according to ASTM D5511.

One or more embodiments generally concern a multilayered flooring product comprising a first layer and a second layer. The first layer comprises a polymer composition containing: (a) at least one inherently non-biodegradable thermoplastic polymer, wherein the inherently non-biodegradable thermoplastic polymer comprises polyvinyl chloride, polyvinyl acetate, polyethylene, polypropylene, ethylene vinyl acetate, acrylonitrile butadiene styrene, ethylene vinyl alcohol, a polycarbonate, a polyurethane, or a combination of two or more thereof; and (b) at least one biodegradation-inducing additive, wherein the biodegradation-inducing additive renders the first layer susceptible to biodegradation under controlled anaerobic conditions. Typically, the biodegradation-inducing additive comprises a glutamic acid derivative, a carboxylic acid or a derivative thereof, an aliphatic polyester, a saccharide, an enzyme, a microorganism, or a combination of two or more thereof. Furthermore, the flooring product exhibits a biodegradation of at least 60 percent after 150 days as measured according to ASTM D5511.

### DETAILED DESCRIPTION

We have discovered how to reformulate current floorcovering formulations and constructions and make them susceptible to biodegradation within a reasonable timescale under controlled anaerobic conditions. Consequently, the biodegradable floorcovering products of the present disclosure may be useful in reducing the volume of landfill sites as the materials degrade. Furthermore, the anaerobic degradation of the thermoplastic polymers can eventually produce, amongst other low molecular weight and gaseous products, methane, which can be recovered from the landfill, thereby providing some value recovery from the scrap materials. Consequently, the floorcovering materials described herein may have various technical, economic, and ecological benefits.

More particularly, the present disclosure is generally concerned with single-layer or multi-layered floorcovering products comprising, consisting essentially of, or consisting of polymer compositions that comprise, consist essentially of, or consist of a synthetic thermoplastic polymer, an optional filler, one or more optional adjuvants, and at least one biodegradable additive that enhances the susceptibility of the thermoplastic polymer to anaerobic biodegradation. For example, in one or more embodiments, at least one the layers in the floorcovering product may contain a biodegradable additive that enhances the susceptibility of the thermoplastic polymer in the formulation to anaerobic biodegradation, thereby providing a floorcovering product that may be biodegraded under controlled anaerobic conditions. Controlled anaerobic conditions may include, but are not limited to, those conditions present in a managed landfill site, or in a commercial waste treatment facility.

Generally, floorcovering products may be divided into two main categories: “soft” and “hard.” Typically, soft floorcovering products are generally woven, non-woven, knitted, and/or tufted products, such as carpets, rugs, and mats, while hard floorcovering products are single-layer or multi-layer constructs of polymer-based formulations. In one or more embodiments described herein, the floorcovering products of the present disclosure are hard floorcovering products. Thus, in one or more embodiments of the present disclosure, the flooring covering products are not soft floorcovering products, such as carpets, rugs, and/or mats. In certain embodiments, the floor covering products of the present disclosure comprise a single-layer or multi-layer construct that is not a carpet, rug, and/or mat. For example, the floor covering product of the present disclosure may be in the form of continuous sheets, blocks, slabs, panels, tiles, and/or laths.

In various embodiments, the floorcovering products of the present disclosure may be manufactured and marketed in a number of forms including, but not limited to, continuous sheets, slabs, panels, blocks, tiles, and laths. It should be noted that, while the present products are described as “floorcovering products,” such products may also apply and be utilized as paneling for walls. In certain embodiments, the floorcovering products may be in the form of luxury vinyl planks, stone polymer composite (“SPC”) flooring, vinyl tile flooring, vinyl wall panels, wood composite flooring and/or panels, light stone plastic composite (“LSPC”) flooring and/or panels, or hybrid polymer composite flooring and/or panels.

Generally, the floorcovering products of the present disclosure may comprise, consist essentially of, or consist of one or more layers of the polymer formulations described herein, wherein the layers may independently be in any suitable form including, but not limited to, solid, foamed, reticulated, and/or textile forms. If in the form of a “textile,” the layer may be in the form of a woven, non-woven, or knitted fabric.

In one or more embodiments, the floorcovering products of the present disclosure may comprise at least 1, 2, 3, 4, or 5 layers. Additionally, or in the alternative, the floorcovering products of the present disclosure may comprise less than 10, 9, 8, 7, 6, 5, 4, or 3 layers. In certain embodiments, the number of layers present in the floorcovering products of the present disclosure may be between 1 and 10, more preferably between 1 and 5, or most preferably between 2 and 5. The layers of the floorcovering products of the present invention may be assembled in any suitable manner known to those skilled in the art including, but not limited to, (co)extrusion, gluing, heat-bonding, pressure-bonding, radiation-bonding, or combinations of these.

The thickness of the floorcovering products of the invention, and the layers therein, can vary depending on the number of layers, the form of the final product, and the intended purpose of the final product (e.g., lightweight products for aircraft, medium weight products for domestic applications, and heavy weight products for use in high traffic areas).

In one or more embodiments, each of the layers within the floorcovering product may have an average thickness of at least 0.1, 0.5, 1, 1.5, 2, 2.5, 3, 3.5, 4, 4.5, 5, 5.5, or 6 mm. Additionally, or in the alternative, each of the layers within the floorcovering product may have an average thickness of less than 20, 19, 18, 17, 16, 15, 14, 13, 12, 11, 10, 9, 8, 7, or 6 mm.

In one or more embodiments, the floorcovering product may have an average thickness of at least 0.1, 0.5, 1, 1.5, 2, 2.5, 3, 3.5, 4, 4.5, 5, 5.5, 6, 6.5, 7, 7.5, or 8 mm. Additionally, or in the alternative, the floorcovering product may have an average thickness of less than 20, 19, 18, 17, 16, 15, 14, 13, 12, 11, 10, 9, 8, 7, or 6 mm. In certain embodiments, the average thickness of the floorcovering product may vary between 2 to 20 mm, and the thickness of the individual layers may vary, independently, between 0.5 to 10 mm. For example, the floorcovering product may comprise a base layer having an average thickness of about 2 to 4 mm, a middle layer having a thickness of 6 to 12 mm, and an upper layer having an average thickness of 4 to 8 mm.

As noted above, each of the layer(s) forming the floorcovering product described herein may comprise, consist essentially of, or consist of a polymer formulation comprising a thermoplastic polymer that is naturally non-biodegradable in anaerobic conditions. In one or more embodiments, the layer(s) may comprise at least 1, 5, 10, 15, 20, 25, 30, 35, 40, 45, 50, 55, 60, 65, 70, 75, 80, 85, 90, 95, 99, or 99.5 weight percent of the polymer formulation, based on the total weight of the layer. In certain embodiments, the layer(s) of the floorcovering product are formed entirely from the polymer formulations described herein.

In one or more embodiments, the polymer formulations may comprise at least 1, 5, 10, 15, 20, 25, 30, 35, 40, 45, 50, 55, 60, 65, 70, 75, 80, 85, 90, or 95 weight percent of one or more of the non-biodegradable thermoplastic polymers described herein, based on the total weight of the polymer formulation. Additionally, or in the alternative, the polymer formulations may comprise less than 95, 90, 85, 80, 75, 70, 65, 60, 55, 50, 45, 40, 35, 30, or 25 weight percent of one or more of the non-biodegradable thermoplastic polymers described herein, based on the total weight of the polymer formulation.

In one or more embodiments, the non-biodegradable thermoplastic polymers useful for the present floorcovering products may include polyvinyl chloride, polyvinyl acetate, polyalkyl acrylates, polyalkyl methacrylates, polyolefins (e.g., polypropylene and/or polyethylene), thermoplastic rubbers, thermoplastic elastomers, polystyrene, ethylene vinyl acetate (“EVA”), acrylonitrile butadiene styrene (“ABS”), ethylene vinyl alcohol (“EVOH”), polyesters (e.g., polyethylene terephthalate), polyamides, polycarbonates, polyurethanes, polyphenylene oxides, polyphenylene sulfides, polysulfones, polyaryletherketones, copolymers thereof, and/or blends of two or more thereof. In certain embodiments, the non-biodegradable thermoplastic polymer comprises a vinyl-based polymer, polyethylene, polypropylene, ABS, EVA, EVOH, a polyurethane, a polycarbonate, or a combination thereof.

Generally, when multiple layers are present in the floorcovering product, the layers may be made of polymer formulations containing the same or different polymer(s). For example, all of the layer(s) within the floorcovering product may contain the same thermoplastic polymer (e.g., a vinyl-based polymer) or each layer may contain a different polymer composition (e.g., a three-layered construct having a PVC base layer, a LSPC mid-layer with ABS, and an SPC upper layer with EVA). Alternatively, in certain embodiments, when multiple layers are present in the floorcovering product, the floorcovering product may comprise at least 1, 2, or 3 layers that do not contain the polymer formulation described herein. In such embodiments, these layers may be formed entirely from the thermoplastic polymers and/or fillers described herein but may not contain the biodegradable additive.

In one or more embodiments, any or all of the polymers used in the polymer formulations may be virgin polymers, mechanically recycled polymers, or chemically recycled polymers, or combinations thereof. Furthermore, any or all of the polymers used in the polymer formulations may be derived from petrochemical and/or renewable resources.

In one or more embodiments, the thermoplastic polymer utilized in forming the various layers of the floorcovering products may be thermoplastic polymers that are synthetic and inherently non-biodegradable under controlled anaerobic conditions over 150 days as measured according to ASTM D5511 and/or ISO DIS15985. As used herein, “inherently non-biodegradable” refers to thermoplastic polymers that exhibit less than 5 percent biodegradation over 150 days under controlled anaerobic conditions as measured according to ASTM D5511.

These inherently non-biodegradable thermoplastic polymers include synthetic thermoplastic polymers which, when exposed to controlled anaerobic conditions, such as in a landfill site or a waste treatment facility, undergo little to no natural degradation due to biodegradation.

As noted above, each of the layer(s) forming the floorcovering product described herein may contain a polymer formulation comprising a biodegradable additive that enhances the susceptibility of the thermoplastic polymer in the formulation to anaerobic biodegradation, thereby providing a layer and/or floorcovering product that may be biodegraded under controlled anaerobic conditions.

The biodegradation-inducing additive may comprise, consistent essentially of, or consist of chemo-attractant compounds, glutamic acid derivatives, carboxylic acids or derivatives thereof, aliphatic polyesters, saccharides, enzymes, and/or microorganisms. Exemplary additives of this type are commercially available from a number of sources including, but not limited to, Restore® (Enso Plastics), EcoPure® (Bio-Tec Environmental), ECM Masterbatch® (Biofilms), BioSphere® (Biosphere Plastics), MECO1® (Hybrid Green), and Eco-One® (Ecologic).

In one or more embodiments, the polymer formulations may comprise a weight ratio of the biodegradation-inducing additive(s) to the thermoplastic polymer(s) of at least 1:1,000, 1:900, 1:800, 1:700, 1:600, 1:500, 1:400, 1:300, 1:200, 1:100, 1:90, 1:85, 1:80, 1:75, 1:70, 1:65, 1:60, 1:55, 1:50, 1:45, 1:40, 1:35, 1:30, 1:25, 1:20, 1:15, 1:10, 1:9, 1:8, 1:7, 1:6, or 1:5. Additionally, or in the alternative, the polymer formulations may comprise a weight ratio of the biodegradation-inducing additive(s) to the thermoplastic polymer(s) of less than 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:35, 1:40, 1:45, 1:50, 1:55, 1:60, 1:65, 1:70, 1:80, 1:85, 1:90, 1:95, or 1:100. In certain embodiments, the polymer formulations may comprise a weight ratio of the biodegradation-inducing additive(s) to the thermoplastic polymer(s) in the range of 1:1,000 to 1:10, 1:500 to 1:20, or 1:200 to 1:65.

In one or more embodiments, the polymer formulations may comprise at least 0.001, 0.005, 0.01, 0.05, 0.1, 0.15, 0.2, 0.25, 0.3, 0.35, 0.4, 0.5, 0.6, 0.7, 0.8, 0.9, 1, 2, 3, 4, or 5 weight percent of one or more of the biodegradation-inducing additives described herein, based on the total weight of the polymer formulation. Additionally, or in the alternative, the polymer formulations may comprise less than 40, 35, 30, 25, 20, 15, 14, 13, 12, 11, 10, 9, 8, 7, 6, 5, 4.5, 4, 3.5, 3, 2.5, 2, 1.5, 1, 0.9, 0.8, 0.7, 0.6, or 0.5 weight percent of one or more of the biodegradation-inducing additives described herein, based on the total weight of the polymer formulation.

The polymer formulations forming the layer(s) in the floorcovering products described herein may also comprise one or more additional adjuvants. These additional adjuvants may be selected from, but are not limited to, one or more of: plasticizers, fungicides, lubricants, particulate fillers, fibrous fillers, antioxidants, heat stabilizers, light stabilizers, UV absorbers, metal deactivators, fire retardants, smoke suppressants, colorants (e.g., pigments), nucleating agents, blowing agents, and/or antistatic agents.

In one or more embodiments, the polymer formulations may comprise at least 0.1, 0.5, 1, 5, 10, 15, 20, 25, 30, 35, 40, 45, 50, 55, 60, 65, 70, 75, 80, 85, 90, or 95 weight percent of one or more of the additional adjuvants described herein, based on the total weight of the polymer formulation. Additionally, or in the alternative, the polymer formulations may comprise less than 95, 90, 85, 80, 75, 70, 65, 60, 55, 50, 45, 40, 35, 30, 25, 20, 15, 10, 9, 8, 7, 6, 5, 4, 3, 2, or 1 weight percent of one or more of the additional adjuvants described herein, based on the total weight of the polymer formulation.

In one or more embodiments, the polymer formulations forming the layer(s) in the floorcovering products described herein may comprise one or more fillers, such as a mineral filler (e.g., calcium carbonate) and/or a natural filler (e.g., softwoods and/or hardwoods).

In one or more embodiments, the polymer formulations may comprise at least 1, 5, 10, 15, 20, 25, 30, 35, 40, 45, 50, 55, 60, 65, 70, 75, 80, 85, 90, or 95 weight percent of one or more fillers, based on the total weight of the polymer formulation. Additionally, or in the alternative, the polymer formulations may comprise less than 95, 90, 85, 80, 75, 70, 65, 60, 55, 50, 45, 40, 35, 30, 25, 20, 15, 10, 9, 8, 7, 6, 5, 4, 3, 2, or 1 weight percent of one or more fillers, based on the total weight of the polymer formulation.

The polymer formulations described herein may be formed using any techniques known in the art, such as homogenization and/or extrusion. For example, the thermoplastic polymer, the biodegradation-inducing additives, and any of the other additives discussed herein may be mixed together and homogenized using conventional mixers known in the art. These homogenization processes may occur at temperatures that will not prematurely degrade the biodegradation-inducing additives.

In one or more embodiments, the polymer formulations may be formed utilizing a two-step process. In the first step, the thermoplastic polymer and any fillers may be combined in a high-speed mixer operating at higher temperatures (e.g., 80 to 120° C.) to thereby form an initial polymer mixture. Next, the biodegradation-inducing additive(s) may be combined with the initial polymer mixture and subjected to additional mixing under less severe mixing conditions and lower temperatures (e.g., 20 to 50° C.). The temperature of this second step may be dictated by the operating conditions of the biodegradation-inducing additive(s). The resulting polymer formulation may then be extruded into sheets or slabs using conventional extruders known in the art.

In various embodiments, one or more of the layers forming the floorcovering products of the present disclosure may be surface decorated with colorants and/or optical effect materials. The decoration may be applied in any suitable manner known to those skilled in the art including, but not limited to, gravure printing, screen printing, lithographic printing, transfer printing, laser printing, spraying, padding, and/or brushing.

Optionally, in various embodiments, the floorcovering products may contain at least 1, 2, or 3 additional layers that do not contain the polymer formulations described herein. These additional layers may comprise, consist essentially of, or consist of biodegradable materials including, but not limited to, natural fabrics, such as cotton, sisal, or jute; solid, foam, or textile layers comprising biodegradable polymers; plant-derived materials, such as wood veneers, fiberboard, cardboard, or paper; and/or felts produced from natural fibers.

Optionally, in various embodiments, the floorcovering products may contain at least 1, 2, or 3 additional layers comprising, consisting essentially of, or consisting of inorganic materials including, but not limited to, glass fiber fabrics and/or mineral fiber fabrics.

The floorcovering products may be formed utilizing any techniques known in the art, such as (co)extrusion, gluing, heat-bonding, pressure-bonding, radiation-bonding, or combinations of these. For instance, various layers formed from various polymer formulations described herein may be stacked and laminated together to form the final product. After combining the layers together, the resulting laminate may then be portioned (e.g., via cutting, stamp tooling, and/or profiling) into the desired shape for the resulting floorcovering product. For example, the laminate may be cut into sheets, blocks, and/or slabs.

The resulting floorcovering products may be waterproof, rigid, and exhibit high dimensional stability. However, most importantly, due to the unique polymer formulations described herein, the floorcovering products may be biodegradable under anaerobic conditions. In one or more embodiments, the layers and/or floorcovering products described herein may exhibit a biodegradation of at least 5, 10, 15, 20, 25, 30, 35, 40, 45, 50, 55, 60, 65, or 70 percent after 150 days as measured according to ASTM D5511.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A flooring product comprising at least one layer, wherein the layer comprises a polymer composition containing at least one inherently non-biodegradable thermoplastic polymer and at least one biodegradation-inducing additive, wherein the biodegradation-inducing additive renders the flooring product susceptible to biodegradation under controlled anaerobic conditions.

2. The flooring product according to claim 1, wherein the flooring product exhibits a biodegradation of at least 40 percent after 150 days as measured according to ASTM D5511.

3. The flooring product according to claim 1, wherein the biodegradation-inducing additive comprises a glutamic acid derivative, a carboxylic acid or a derivative thereof, an aliphatic polyester, a saccharide, an enzyme, a microorganism, or a combination of two or more thereof.

4. The flooring product according to claim 3, wherein the inherently non-biodegradable thermoplastic polymer comprises polyvinyl chloride, polyvinyl acetate, a polyalkyl acrylate, a polyalkyl methacrylate, a polyolefin, a thermoplastic rubber, a thermoplastic elastomer, polystyrene, ethylene vinyl acetate, acrylonitrile butadiene styrene, ethylene vinyl alcohol, a polyester, a polyamide, a polycarbonate, a polyurethane, a polyphenylene oxide, a polyphenylene sulfide, a polysulfone, a polyaryletherketone, or a combination of two or more thereof.

5. The flooring product according to claim 3, wherein the inherently non-biodegradable thermoplastic polymer comprises polyvinyl chloride, polyvinyl acetate, polyethylene, polypropylene, ethylene vinyl acetate, acrylonitrile butadiene styrene, ethylene vinyl alcohol, a polycarbonate, a polyurethane, or a combination of two or more thereof.

6. The flooring product according to claim 3, wherein the layer comprises at least 50 weight percent of the polymer composition, based on the total weight of the layer.

7. The flooring product according to claim 6, wherein the polymer composition comprises at least 80 weight percent of the thermoplastic polymer, based on the total weight of the polymer composition.

8. The flooring product according to claim 7, wherein the polymer composition comprises 0.001 to 5 weight percent of the biodegradation-inducing additive, based on the total weight of the polymer composition.

9. The flooring product according to claim 8, wherein the polymer composition comprises at least 25 weight percent of a mineral filler, a natural filler, or a combination thereof, based on the total weight of the polymer composition.

10. The flooring product according to claim 9, wherein the polymer composition comprises the mineral filler.

11. The flooring product according to claim 8, wherein the layer consists of the polymer composition.

12. The flooring product according to claim 8, wherein the flooring product is in the form of a sheet, plank, or tile.

13. A multilayered flooring product comprising a first layer and a second layer, wherein the first layer comprises a polymer composition containing at least one inherently non-biodegradable thermoplastic polymer and at least one biodegradation-inducing additive, wherein the biodegradation-inducing additive renders the first layer susceptible to biodegradation under controlled anaerobic conditions, wherein the flooring product exhibits a biodegradation of at least 50 percent after 150 days as measured according to ASTM D5511.

14. The multilayered flooring product according to claim 13, wherein the biodegradation-inducing additive comprises a glutamic acid derivative, a carboxylic acid or a derivative thereof, an aliphatic polyester, a saccharide, an enzyme, a microorganism, or a combination of two or more thereof.

15. The multilayered flooring product according to claim 14, wherein the inherently non-biodegradable thermoplastic polymer comprises polyvinyl chloride, polyvinyl acetate, a polyethylene, polypropylene, ethylene vinyl acetate, acrylonitrile butadiene styrene, ethylene vinyl alcohol, a polycarbonate, a polyurethane, or a combination of two or more thereof.

16. The multilayered flooring product according to claim 15, wherein the polymer composition comprises:
(a) at least 85 weight percent of the thermoplastic polymer, based on the total weight of the polymer composition; and
(b) 0.1 to 3 weight percent of the biodegradation-inducing additive, based on the total weight of the polymer composition.

17. The multilayered flooring product according to claim 16, wherein the polymer composition comprises a mineral filler.

18. The multilayered flooring product according to claim 16, wherein the flooring product is in the form of a sheet, plank, or tile.

19. A multilayered flooring product comprising a first layer and a second layer, wherein the first layer comprises a polymer composition containing:
(a) at least one inherently non-biodegradable thermoplastic polymer, wherein the inherently non-biodegradable thermoplastic polymer comprises polyvinyl chloride, polyvinyl acetate, polyethylene, polypropylene, ethylene vinyl acetate, acrylonitrile butadiene styrene, ethylene vinyl alcohol, a polycarbonate, a polyurethane, or a combination of two or more thereof; and
(b) at least one biodegradation-inducing additive, wherein the biodegradation-inducing additive renders the first layer susceptible to biodegradation under controlled anaerobic conditions, wherein the biodegradation-inducing additive comprises a glutamic acid derivative, a carboxylic acid or a derivative thereof, an aliphatic polyester, a saccharide, an enzyme, a microorganism, or a combination of two or more thereof;
wherein the flooring product exhibits a biodegradation of at least 60 percent after 150 days as measured according to ASTM D5511.

20. The multilayered flooring product according to claim 19, wherein the polymer composition comprises calcium carbonate.
